(19) United States
(12) Patent Application Publication
(10) Pub. No.: US 2012/0301361 A1
(43) Pub. Date: Nov. 29, 2012

(54) PORTABLE CHEMICAL DETECTOR

(75) Inventor: Marion H. Cates, Springville, AL (US)

(73) Assignee: MEADOWORKS, INC., Rupert, WV (US)

(21) Appl. No.: 13/114,995

(22) Filed: May 24, 2011

(51) Int. Cl. G01N 21/75

(52) U.S. Cl. 422/82.05

(57) ABSTRACT

A portable chemical detector, an embodiment including a material that contains a dye and is permeable to one or more chemicals that activate the dye, a light emitter to transmit light through the material and dye, a light detector to detect the light and a housing in which the material containing the dye, the light emitter, and the light detector are disposed.

### FIELD OF THE INVENTION

This invention is related to chemical detection, and more particularly to methods and apparatuses for detecting chemicals directly on a person or on a fixed or other location.

### BACKGROUND OF THE INVENTION

Chemical exposure is a major concern in the industrial and environmental fields, Homeland Defense, and the military. Millions are spent each year in attempting to address that concern.

Various monitors and detectors are currently used to measure chemical exposure. Those devices have one or more limitations. For example, some of those devices are large and bulky and thus not easily portable. Some devices are limited to short monitoring times, after which they must be renewed, such as by replacing batteries or sensing elements. Other devices have limitations such as requiring significant training and expertise to enable analysis of the chemicals detected by the device. Some devices do not have alarms to alert a user to chemical exposure. Some devices may provide little or no historical data and may not act as dosimeters. Further, some devices are expensive.

Accordingly, there may be a need for a chemical detector that may overcome at least some of those drawbacks. For example, there may be a need for an inexpensive, small, low power, multiple chemical, and/or easily portable chemical detectors that provides reliable monitoring of chemicals such as toxic industrial chemicals and chemical warfare agents.

### BRIEF DESCRIPTION OF THE DRAWINGS

The accompanying drawings, wherein like reference numerals are employed to designate like components, are included to provide a further understanding of chemical detectors, are incorporated in and constitute a part of this specification, and illustrate embodiments of a chemical detector that together with the description serve to explain the principles of chemical detectors.

Various other objects, features and advantages of the invention will be readily apparent according to the following description exemplified by the drawings, which are shown by way of example only, wherein:

FIG. 1 illustrates an exploded perspective view of a chemical detector, in accordance with one embodiment of the present invention;

FIG. 2 illustrates a top view of a chemically-activatable element that may be used in a chemical detector, in accordance with one embodiment of the present invention;

FIG. 3 illustrates a top view of elements that may be used as part of a chemical detector, in accordance with various embodiments of the present invention;

FIG. 4 illustrates a side view of the elements in the embodiment of FIG. 3;

FIG. 5 illustrates a top view of a chemical detector, in accordance with one embodiment of the present invention;

FIG. 6 illustrates a top view of elements that may be included in the interior of the housing of the chemical detector of FIG. 5, in accordance with one embodiment of the present invention;

FIG. 7 illustrates a front view of a material permeable to a chemical and having a star-shaped cross-section;

FIG. 8a illustrates an end view of a material permeable to a chemical, in accordance with one embodiment;

FIG. 8b illustrates a cross-sectional front view of the material of FIG. 8a at a central portion along its length; and

FIG. 8c illustrates an opposing end view of the material of FIG. 8a.

### DETAILED DESCRIPTION

Reference will now be made to embodiments of chemical detectors, examples of which are illustrated in the accompanying drawings. Details, features, and advantages of the chemical detectors will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

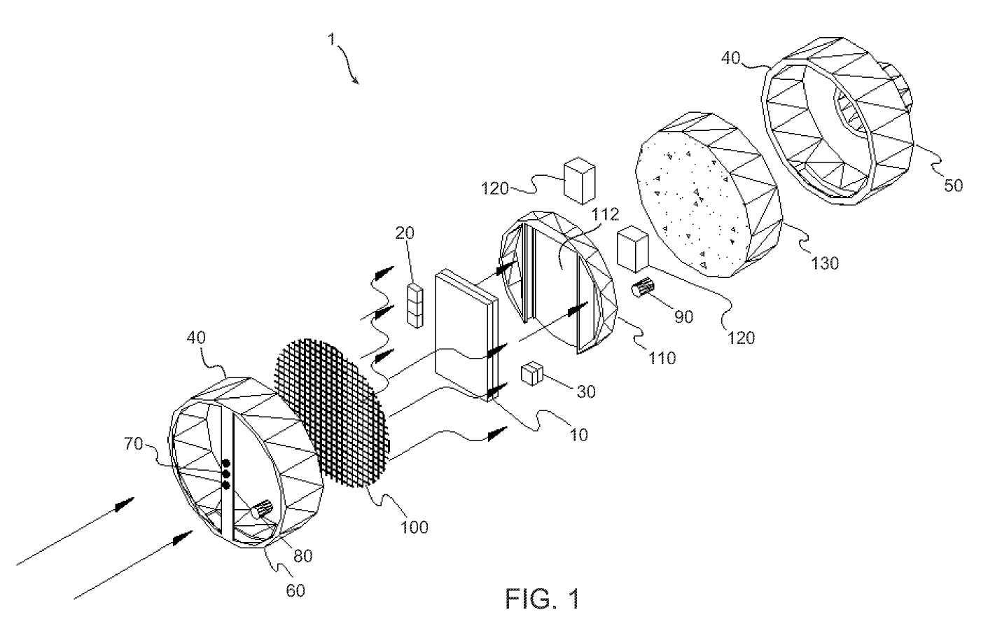

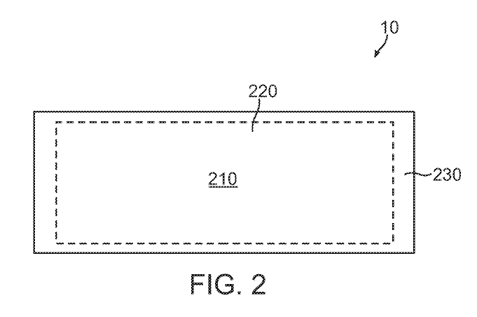

FIG. 1 illustrates an exploded perspective view of a chemical detector 1, in accordance with one embodiment. The chemical detector 1 may include a chemically-activatable assembly 10, a light emitter 20, and a light detector 30. The chemically-activatable assembly 10 may be exposed to the air and include a material containing a chemically reactive dye. The material may be a desired material, such as one described below with respect to the material 210 of FIG. 2. The dye may be contained by the material in various ways in various embodiments. For example, the material may be impregnated with the dye, the dye may be embedded in the material, or the material may be mixed with, saturated with, or otherwise include the dye. The dye may be activatable by one or more chemicals such that the dye is activated by those one or more chemicals, as described herein. Thus, depending on the permeability of the material or materials of the chemically-activatable assembly 10, as also described herein, the dye in the chemically-activatable assembly 10 may react with one or more chemicals in the air. That reaction may change the light-transmittance characteristics of, and thus “activate,” the dye. For example, when the dye is exposed to a certain chemical, the dye may continue to change the transmittance of light during the exposure. The dye may be one of various types in different embodiments, such as described below with respect to the dye 220 of FIG. 2, for example.

In one embodiment, the chemically-activatable assembly 10 includes a protective material, such as described below. Various other embodiments of chemically-activatable assemblies are discussed herein, such as with respect to FIG. 2.

The light emitter 20 may be any kind of device that emits light, such as a light-emitting color diode, which is used in one embodiment. The light emitter 20 may transmit light through the chemically-activatable assembly 10. As disclosed above, the light-transmittance characteristics of the dye may change as the dye changes color by exposure to the chemical or chemicals that activate it. Light not absorbed or reflected by the dye may project through the dye to the light detector 30. Thus, the light emitter 20 may be positioned on one side of the chemically-activatable assembly 10, and the light detector 30 may be positioned on the other side so that at least some of the light from the light emitter 20 passes through the chemically-activatable assembly 10 and becomes incident on the light detector 30.

In an embodiment, the light detector 30 is a photodiode or another device that detects rate of change of intensity of light. The light detector 30 may thus receive and detect the light that is transmitted from the light emitter 20 through the chemically-activatable assembly 10 (and thus material the dye). The light detector 30 may transmit signals corresponding to the rate of change of received light intensity of one or more wavelengths of light, and thus signals corresponding to the rate of change of light intensity of one or more wavelengths transmitted through the dye. The light detector 30 may transmit those signals to one or more processors 120. The one or more processors 120 may process those signals to identify a concentration of the chemical or chemicals that activated the dye of the chemically-activatable assembly 10. The operation of the one or more processors 120 is described below.

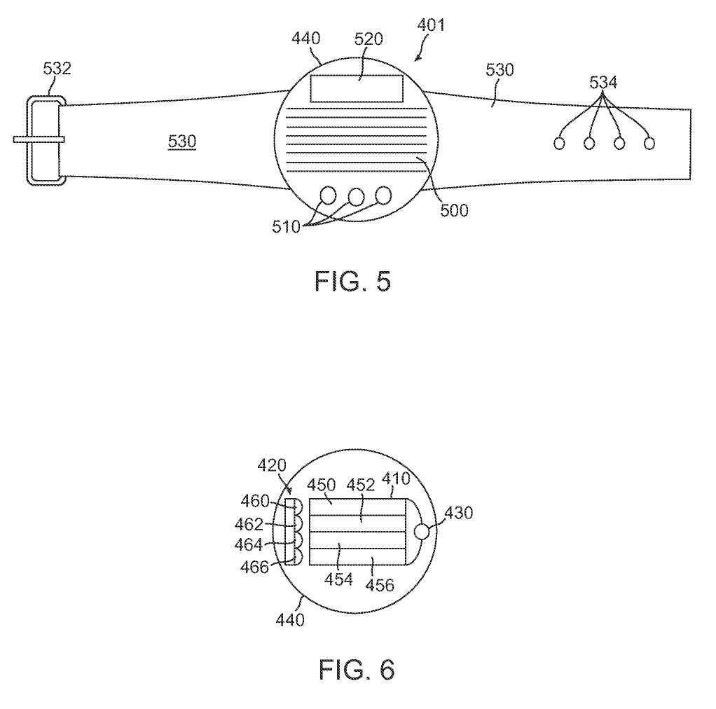

In an embodiment, the chemical detector 1 may include a housing 40. The housing 40 may be made of any substance and shaped as desired. The housing 40 may, in an embodiment, include a main housing 50 and an outer housing 60. The main housing 50 and outer housing 60 may be attached in any way desired, such as by epoxy, snap-fit, screw, or any other means. The chemically-activatable assembly 10, light emitter 20, and light detector 30 may be disposed in the housing 40. The outer housing 60 or another part of the housing 40 may include a status display 70 thereon. The status display 70 may include one or more indicating lights such as light-emitting diodes, which may provide various indications. For example, one light-emitting diode may indicate that the air is safe such that the air contains no concentration of a chemical that may be dangerous. Another light-emitting diode may indicate that the chemical detector 1 requires maintenance or service. The status display 70 may provide those and/or other indications using light-emitting diodes or other means. In an embodiment, the status display 70 also or alternatively includes an indicator screen providing various indications, such as the indicator screen 520 and its various possible indications described below with respect to FIG. 5.

The chemical detector 1 may include various other components, which may be disposed in the housing 40. In an embodiment, the chemical detector 1 includes one or more of alignment elements 80 and 90, a light-blocking diffusion screen 100, a holder 110 for the chemically-activatable assembly 10, one or more processors 120, and a power source 130. The aforementioned elements 80 and 90, 100, 110, 120, and 130 may be disposed in the housing 40 in one embodiment.

In an embodiment, the outer housing 60 has an opening that allows air to enter the chemical detector 1. In another embodiment, the outer housing 60 is made of a substance that is permeable to at least the chemical or chemicals that are to be detected by the chemical detector 1. In other embodiments, another part of the housing 40 may be open to allow air to enter the chemical detector 1.

As described above, the outer housing 60 may be formed such that it allows air and/or a chemical or chemicals to pass through the outer housing 60. The outer housing 60 may in addition or alternately permit light to pass through by, for example, making the outer housing 60 of a clear, transparent, or translucent substance. The light-blocking diffusion screen 100 may be disposed adjacent to the outer housing 60 to block this light from passing through it to the chemically-activatable assembly 10. Thus, in an embodiment, most or all of the light that passes through the chemically-activatable assembly 10 (and thus the dye therein) will be the light emitted by the light emitter 20 to improve the chemical-detecting accuracy of the chemical detector 1. Other means for blocking light exterior to the chemical detector 1 from passing through the chemically-activatable assembly 10 may be used if desired, such as described herein.

In an embodiment, the holder 110 may be included in the chemical detector 1. The holder 110 may include a recess 112 to position the chemically-activatable assembly 10 therein. If desired, the recess 112 may have dimensions close to those of the chemically-activatable assembly 10 to more securely or precisely position the chemically-activatable assembly 10. The recess 112 and/or another portion of the holder 110 may be dimensioned to accommodate the light detector 30 and possibly the light emitter 20 therein.

The chemical detector 1 may include first and second alignment elements 80 and 90, respectively, to align the outer housing 60 with the holder 110. The alignment element 80 may be disposed on or in the outer housing 60, such as at least partly extending from a portion on the interior of the chemical detector. The alignment element 90 may be disposed on or in the holder 110, such as at least partly extending toward the outer housing 60. The alignment elements 80 and 90 may be adjacently positioned to secure the outer housing 60 and holder 110 in the aforementioned alignment. In various embodiments, the alignment elements 80 and 90 may be pegs, may be or include a pin on one of the first or second alignment elements 80 or 90 and an oppositely shaped recess into which the pin may extend on the other of the first or second alignment elements 80 or 90, or may be other aligning elements.

The one or more processors 120 may include one or more computers such as microprocessors or microcontrollers each having a central processor and memory, or may be any electronic device or devices that can process electric signals sent from the light detector 30. The one or more processors 120 may include one or more other elements if desired. The electric signals may correspond, as discussed above, to the rate of change of received light intensity of one or more wavelengths of light. In an embodiment, each signal provides information regarding light intensity of one or more wavelengths of light. The one or more processors 120 process those signals to determine the change in the light intensity over time. The one or more processors 120 may thus determine whether and to what extent the dye was activated, and thus whether and to what extent the light-transmittance characteristics of the dye were changed. By determining the characteristics of that activation, the one or more processors 120 may determine the existence and concentration in the air of the chemical or chemicals that activated the dye. The one or more processors 120 may also include various input/output elements and/or one or more other elements used in computers, as desired.

The power source 130 may provide power to one or more of the light emitter 20, light detector 30, status display 70, and one or more processors 120. In other embodiments, one or more of the light emitter 20, light detector, 30, and one or more processors 120 may be self-powered. The power source 130 is a battery in an embodiment, but may be another type of power source in another embodiment.

FIG. 2 illustrates a top view of one embodiment of a chemically-activatable assembly 10 or part thereof that may be used in a chemical detector, such as the chemical detector 1 of FIG. 1. The chemically-activatable assembly 10 may include a material 210 and a dye 220. The material 210 may be permeable to one or more chemicals. The material 210 may allow light to pass through, meaning the light from the light emitter 20 will also pass through the dye 220 contained by the material 210. As described herein, where the dye 220 is activated by a chemical and changes its light-transmittance characteristics, the light-transmittance characteristics of the material 210 containing the dye will change. The dye 220 may be contained by the material 210 in various ways in various embodiments. For example, as described above, the material 210 may be impregnated with the dye 220, the dye 220 may be embedded in the material 210, or the material 210 may be mixed with, saturated with, doped with, or otherwise contain the dye 220.

As described above, the dye 220 may be activated by one or more chemicals to which the material 210 is permeable. Thus, as described above, the light-transmittance characteristics of the dye 220 may change when the dye 220 reacts with that chemical or those chemicals.

For example, referring to FIGS. 1 and 2, air may enter the chemical detector 1, such as through the outer housing 60 or other part of the housing 40. If the air includes a chemical to which the material 210 is permeable and that chemical activates the dye 220, the dye 220 may change its light-transmittance characteristics, such as by changing color, when it reacts with the chemical. The light emitter 20 emits light and may, for example, be a colored light emitting diode. In an embodiment, the light emitted by that light emitter 20 may pass somewhat to entirely through the material 210 containing the dye 220, absent the presence of a chemical that activates the dye 220.

The light detector 30 may thus detect a certain intensity of light that passed through the chemically-activatable assembly 10. However, when a chemical reacts with and thus activates the dye 220, the rate of change of light intensity at one or more wavelengths transmitting through the dye 220 may change. As described above, the light detector 30 may receive that changing intensity of light and determine that rate of change. The light detector 30 may then transmit each signal corresponding to a light intensity to the one or more processors 120 for further processing. The one or more processors 120 may process those signals to determine the change in light intensity over time, with that time determined based on the frequency of the received signals.

Thus, for example, the light emitter 20 may be a color diode that emits red light that generally passes through the material 210 and dye 220 when the dye 220 is not activated. However, when the dye 220 is activated by a chemical, the dye 220 may decrease the transmittance of red light, and may thus allow progressively less red light to pass through to the light detector 30 over the time that the dye is exposed to the chemical. The light detector 30, such as a photodiode, may continuously detect the intensities of received light and continuously transmit signals representing those intensities to the one or more processors 120. The one or more processors 120 may process those signals to determine the rate of change of intensity of the red light it receives over time. Based on that rate of change of intensity, the one or more processors 120 may then determine the chemical or chemicals present, along with their concentration. The one or more processors 120 may be coupled with the status display 70 and may actuate the display to represent the presence and possibly the concentration (or other indication such as a warning, if applicable) of the chemical. In another embodiment, the chemical detector 1 may alternatively or additionally include an audible alarm (not shown) that may be disposed in the housing, and the one or more processors 120 may be coupled with that alarm. If the concentration of the chemical exceeds a predetermined level, the one or more processors 120 may prompt the alarm to be actuated.

The material 210 can be of various types in various embodiments. For example, the material 210 may be a solid, semi-solid such as a gel, or a liquid. In various embodiments, the material 210 may have one or more of various characteristics. For example, the material 210 may be clear or translucent to allow light to travel through, may be stable and not significantly degraded or otherwise changed over time, and/or may allow speedy diffusion of gas or vapor being measured. In various embodiments, the material 210 may be able to be molded, casted, machined, or otherwise capable of being formed into a desired shape. The material 210 may be compatible with the dye 220 such that they do not chemically react with each other.

Examples of materials that may be used for the material 210 in various embodiments are as follows: silicones such as RTV polymeric silicones resembling rubber, such as Silastic®; methyl silicone; reactive silicone materials that make clear or translucent solid silicones; clear Teflon® materials such as PFA Teflon®; various clear polymers including plastics, such as clear polystyrene, polypropylene, polyethylene, and vinyl; and various aqueous or non-aqueous gels or solids, such as waxes and silica matrix. For example, in one embodiment, the material 210 is a silicone strip. Other materials may be used for the material 210.

The material 210 may be shaped as desired, since its shape may affect the transmittal of light and chemicals through them. In an embodiment, the material 210 is a cylindrical bar or other elongated element. In this embodiment, the light emitter 20 may be positioned near one end of the elongated element and the light detector 30 may be positioned near the other end. The light emitter 20 may transmit light through the end of the elongated element it is nearest such that the light travels through the elongated element from that end to and out of the other end to the light detector 30 positioned near that other end. The light-transmittance characteristics of the dye 220 contained by the material 210 due to any chemical activation may alter the amount of light that passes through the elongated element. Transmitting light lengthwise by the light emitter 20 through the elongated element may increase sensitivity in measuring the chemical concentration, which may improve accuracy in measuring low concentrations of chemicals.

In various embodiments, a material having a star-shaped cross-section or otherwise including a cross-section having multiple fingers extending from a central portion may be used as one or more of the materials in any of the chemical detector embodiments described herein. The fingers may be shaped with a desired length and thickness (which may vary or may be consistent, at least over part of its length, as desired). The material may otherwise include one or more elements described herein with respect to the material 210 or another material described herein (e.g., 312, 316). Such a shape increases the surface area of the material as compared to some other shapes. The increased surface area may improve detection of low levels of the chemical that activate any contained dye (such as any embodiment of dye 220 described herein with respect to the material 210) since more of the dye will be exposed for activation.

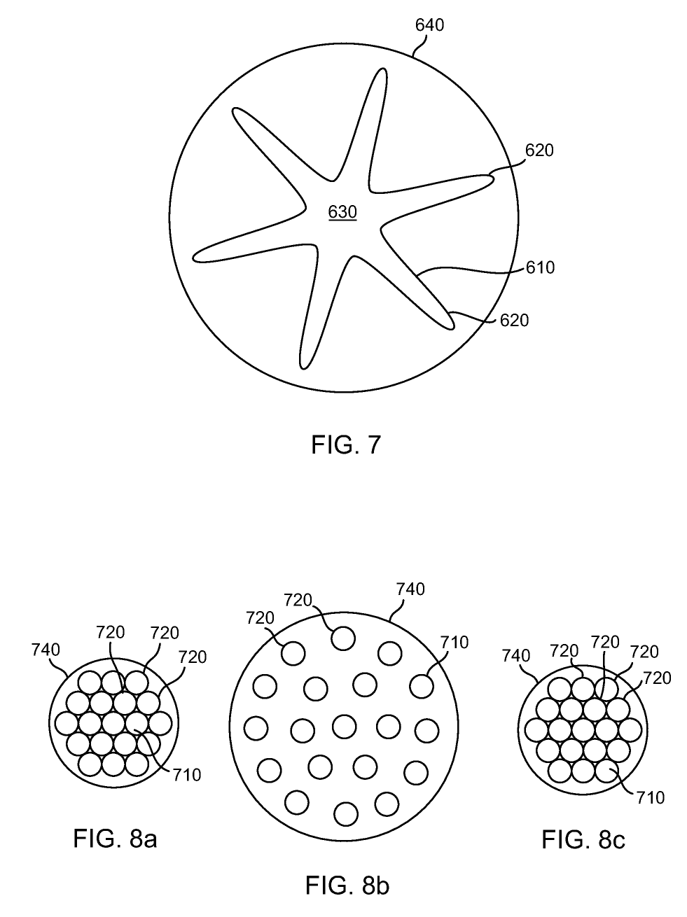

For example, FIG. 7 illustrates a front view of a material 610 permeable to a chemical and having a star-shaped cross-section. The material 610 includes multiple fingers 620 (six in this embodiment) extending from the central portion 630 of the material 610. The material 610 may have other elements described herein with respect to the material 210 or another material described herein.

The material 210 may have other shapes in other embodiments, such as a shape with a cross-section that is circular, square, or triangular. These and other shapes of materials 210 or other materials herein may be formed by extrusion or other methods. With any shape, a mask may be included. The mask may be a baffle, sheath, cover, or other element positioned around, and possibly close to or adjacent to, the material 210 or other material herein to block light from being transmitted to a photodiode except from the light emitter through the material 210 or other material. The mask may allow the chemical or chemicals to be detected to move therethrough. That element may be in place of or in addition to a diffusion screen 100 or 352 described herein or another diffusion screen. Thus, for example, regarding the material 610 in FIG. 7, a mask 640 may surround the material 610 such that light may only enter and exit the material 610 through its ends and not elsewhere.

In another embodiment, the material is shaped with such that it includes multiple thin fibers that are bundled or otherwise positioned close together near the ends of the material but are spread out away from the ends. For example, FIG. 8a-8c show cross-sectional views of a material 710 that includes multiple fibers 720. FIGS. 8a and 8c show end views of the two ends of the material 710. At those ends, the fibers 720 are bundled together. FIG. 8b shows a cross-sectional front view of the material 710 at a central portion along its length. At this central portion, the fibers 720 are spread apart as compared to their relatively close positioning at the ends of the material 710.

As with the star-shaped cross-section embodiment of the material, material 610 of FIG. 7, a material including multiple thin fibers spread apart away from its ends increases the surface area of the material, thus exposing more material for activation. The fibers in this embodiment may be spread out away from the light emitter (e.g., diodes 320, 322, and 324) and photodiodes (e.g., 330, 332, 334 described below) to provide more exposed surface area to receive a chemical or chemicals to be detected. The convergence of the fibers near the light emitter may prevent most light from the light emitter from travelling to the photodiodes without travelling through the fibers. The convergence of the fibers near the photodiodes may also improve detection by the photodiodes. The material 710 may include a mask 740 that surrounds the material 710 such that light may only enter and exit the material 710 through its ends and not elsewhere.

In another embodiment, the material is like the material 710 in that it includes multiple fibers 720, but each fiber has a star-shaped cross-section, such as the shape of the material 610, for example.

In another embodiment, the material 210 is bulbous, such as thicker in a middle portion of the material 210 with respect to its ends.

The dye 220 may be one of various types in various embodiments. The dye 220 may be synthetic or natural, and may be initially clear or colored, and may or may not turn a color, such as purple, blue, red, green, or yellow, for example, when exposed to a chemical. In an embodiment, the dye 220 is clear and turns a color, thus increasing its opacity to one or more of the aforementioned colors when exposed to a certain chemical, as described herein, thus changing its light-transmittance characteristics in different portions of the electromagnetic spectrum. In another embodiment, the dye 220 is initially colored and changes color when exposed to a certain chemical, thus changing its opacity and light-transmittance characteristics.

In another embodiment, also shown in FIG. 2, the chemically-activatable assembly 10 includes the material 210 and dye 220, and further includes a protective material 230. The protective material 230 may be a material that is impermeable to certain substances, such as water and certain other substances in air and one or more chemicals. The protective material 230 may allow enough light to pass through such that enough of the light from the light emitter 20 to be detectable by the light detector 30 passes through.

The material 210 may be contained by the protective material 230. The material 210 and protective material 230 may both be permeable to one or more of the same chemicals. In that embodiment, the dye 220 may be activatable by one of that or those same chemicals. The one chemical may thus penetrate both the protective material 230 and then the material 210 and react with the dye 220. That reaction may change the light-transmittance characteristics of the dye 220, which can be detected and measured by the chemical detector 1 to detect the presence and concentration of that chemical, such as described herein.

For example, referring to FIGS. 1 and 2, air may enter the chemical detector 1, such as through the outer housing 60 and/or another part of the housing 40. The light emitter 20, such as a color diode, may emit light, which may pass somewhat to entirely through the protective material 230. Without presence of the chemical in the air, the emitted light may further pass somewhat to entirely through the material 210 containing the dye 220. The light detector 30 may thus detect a certain intensity of light that passed through the chemically-activatable assembly 10 in the absence of that chemical. However, if the air includes a chemical to which the material 210 and protective material 230 are permeable and that activates the dye 220, the dye 220 may change its light-transmittance characteristics when reacting with the chemical, such as by changing its opacity to the color of light emitted by the light emitter 20. The operation of this embodiment of the chemically-activatable assembly 10 may thus be similar to that of the chemically-activatable assembly 10 discussed above (which does not include the protective material 230). However, the protective material 230 may provide additional protection from the air, such as by protecting the surface of the material 210 from degradation from exposure to the air. In an embodiment in which the dye 220 is present on the surface of the material 210, such as when the material 210 contains the dye 220 by suffusion, the protective material 230 may provide protection against degradation of the dye 220 on that surface.

As with the material 210 as described above, the protective material 230, if included in the chemically-activatable assembly 10, may be of various types. In various embodiments, the protective material 230 may be a solid or semi-solid, for example, and may have various other characteristics and include various materials such as those described with respect to the material 210.

The protective material 230 may also be shaped as desired. For example, the protective material 230 may be shaped as an open container, such as a cup with an open top. In this embodiment, the protective material 230 may be impermeable to the chemical to be detected (and which activates the dye 220), and thus the chemical may have to travel through that open top to encounter the material 210 and dye 220.

In one embodiment, the protective material 230 includes glass and is tubular and contains the material 210 and dye 220.

In another embodiment, the material 210 is a liquid or semi-solid such as a gel, and the protective material 230 is a membrane that that surrounds the liquid or semi-solid. The membrane may be impermeable to water and certain atmospheric gases. In that embodiment, the material 210 may be mixed with or otherwise contain the dye 220.

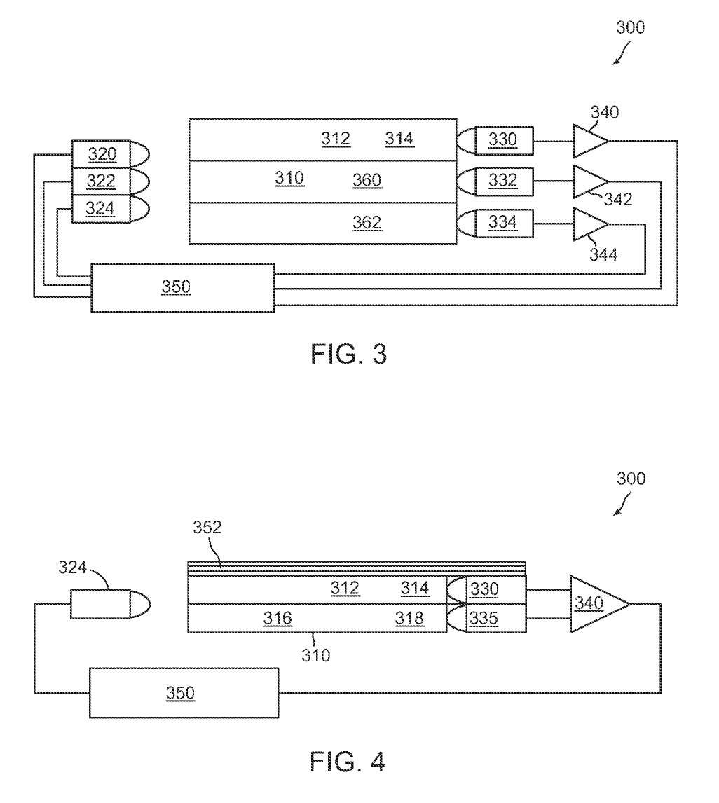

FIGS. 3 and 4 illustrate a top view and side view, respectively, of embodiments of elements 300 that may be used as part of a chemical detector and may be disposed in the housing, such as in place of corresponding elements (where applicable) or additionally in the chemical detector 1 of FIG. 1 described above, in accordance with various embodiments. FIG. 3 shows elements 300 including a chemically-activatable assembly 310 including materials 312, 360, and 362, as described below. FIG. 4 shows an embodiment of elements 300 including just the material 312 and a corresponding reference material 316, though as described below, one or more of the materials 360, 362 and reference materials corresponding to 360, 362 may be included in other embodiments.

In one embodiment, the elements 300 include a chemically-activatable assembly 310, a light emitter including one or more of diodes 320, 322, and 324, a light detector including one or more of photodiodes 330, 332, and 334, one or more differential amplifiers 340, 342, and 344, processor 350, and a light-blocking diffusion screen 352. In other embodiments, one or more of those elements may be excluded.

In one embodiment, the elements 300 include a chemically-activatable assembly 310 that includes one or more materials and dyes. For example, as shown in FIG. 4, the chemically-activatable assembly 310 may include one or more additional materials such that there are at least two materials and at least one dye, that is, a material 312 containing a first dye 314, and a reference material 316 that may or may not include a reference dye 318. In various embodiments, the materials 312 and 316 may be the same or different and the dyes 314 and 318 (if included) may be the same or different. In this embodiment, the elements 300 may include a light emitter such as a light-emitting diode, e.g., one of light-emitting diodes 320, 322, and 324, which are described below. That light-emitting diode may transmit light through both the material 312 and reference material 316 and thus also their contained dyes 314 and (if present) 318.

In various embodiments that exclude the reference dye 318 and in which the reference material 316 is the same type and shape as that of the material 312, the reference material 316 may be a reference. That is, the reference material 316 may be used to account for changes in the light-transmittance characteristics of the material 312 due to degradation and other changes not due to activation of the first dye 314. Thus, for example, in one such embodiment, the material 312 and reference material 316 are each of silicone type and are shaped as an elongated, cylindrical bar. In this embodiment, when a particular chemical encounters the chemically-activatable assembly 310 and activates the first dye 314, the light-transmittance characteristics of the first dye 314, and thus the light transmittance through the material 312 containing the first dye 314, change. As described below, a chemical detector in which the chemically-activatable assembly 310 is included may determine the rate of change in light-transmittance at one or more wavelengths both for light passing through the material 312 (and thus the first dye 314) and the reference material 316. The difference in the two rates of change can be determined as described below, thus providing the rate of change due primarily to the activation of the first dye 314, and thus accounting for the degradation in the materials 312 and 316.

In various embodiments including a reference dye 318 that is the same type as the first dye 314 and in which the reference material 316 is the same type and shape as that of the material 312, the reference material 316 containing the reference dye 318 may be a reference. In this embodiment, the reference material 316 and reference dye 318 may be encased by or otherwise contained by a protective material that is impermeable to the chemical that activates the reference dye 318. The reference material 316 containing the reference dye 318 may thus be used to account for changes in the light-transmittance characteristics of the material 312 and its contained first dye 314 due to their degradation and other changes not due to activation of the first dye 314.

In various embodiments, the chemically-activatable assembly 310 may include a light emitter having one or more of diodes, such as diodes 320, 322, and 324. The diode 320 may be a yellow light-emitting diode, the diode 322 may be a blue light-emitting diode, and the diode 324 may be a red light-emitting diode. In this embodiment, three materials 312, 360, and 362 may be present in the chemically-activatable assembly 310 and may or may not be of different types. Each material 312, 360, and 362 may contain a different dye and be permeable to a chemical that activates that dye. Each material 312, 360, and 362 may receive light from all of the diodes 320, 322, and 324. The material 312 may include the first dye 314, which, when exposed to the chemical that activates it, may change its opacity one or more of the yellow light emitted from the yellow light-emitting diode 320, the blue light emitted from the blue light-emitting diode 322, and the red light emitted from the red light-emitting diode 324. Similarly, the dyes contained by the additional materials, second and third materials 360 and 362, may respectively change their opacity to light emitted from one or more of the diodes 320, 322, and 324.

As with embodiments above including a reference material 316 and possibly a reference dye 318, various embodiments of the chemically-activatable assembly 310 including more than one material, such as the three materials 312, 360, and 362 shown in FIG. 3, may also include a plurality of reference materials, such as three reference materials (one of which is shown in FIG. 4 as 316) corresponding to the three materials 312, 360, and 362, that may or may not each have a corresponding reference dye. In an embodiment in which those corresponding reference materials each include a reference dye, those reference materials may be encased or otherwise contained by a protective material or materials that are impermeable to the chemicals that activate the dyes. Changes in the light-transmittance characteristics of the three materials and, if applicable, their three contained dyes due to degradation and other non-activation changes may be measured by the chemical detector in which they are included. In these embodiments including multiple reference materials, the multiple light-emitting diodes (e.g., 320, 322, and 324) may transmit light through both the materials 312, 360, and 362 and those materials' corresponding reference materials (e.g., 316).

As described above, the elements 300 may include, in addition to the chemically-activatable assembly 310 and one or more diodes 320, 322, and 324 discussed above, a light detector including one or more photodiodes 330, 332, and 334, and possibly 335 (and two other photodiodes not shown but corresponding to photodiodes 332 and 334), one or more differential amplifiers 340, 342, and 334, a processor 350, and a light-blocking diffusion screen 352.

The light detector may include, in embodiments in which no reference materials are included, just the photodiodes 330, 332, and 334.

In various embodiments, the elements 300 may include one or more differential amplifiers 340, 342, and 344. The one or more differential amplifiers 340, 342, and 344 may amplify the signals transmitted by the photodiodes 330, 332, and 334, respectively (and possibly 335 and two other photodiodes not shown but corresponding to photodiodes 332 and 334, respectively) to increase the accuracy of measurement by the one or more processors (e.g., 350 described below) of the rate of change (or difference in rate of change when the photodiodes 335 and two corresponding photodiodes 332 and 334 are present) in light-transmittance characteristics those signals represent. Such amplification may improve accuracy in determining those values, especially in cases in which the signals transmitted by the photodiodes 330, 332, and 334 or photodiodes 330, 332, 334, 335 and those corresponding to 332 and 334 are weak or the difference between the rates of change in light-transmittance characteristics as represented by signals transmitted by the photodiodes 330, 332, and 334 or photodiodes 330, 332, 334, 335 and those corresponding to 332 and 334 is small.

The elements 300 may also include one or more processors 350. The one or more processors 350 may include one or more elements included in the one or more processors 120 described above, and may include a general purpose input/output (GPIO) and, if the elements 300 include differential amplifiers 340, 342, and 344, audio/digital converters for those amplifiers. The one or more processors 120 in embodiments above regarding FIG. 1 may include one or more of the GPIO and differential amplifier if desired.

In an embodiment in which the elements 300 are used in the chemical detector 1, the chemically-activatable assembly 310 may replace the chemically-activatable assembly 10, the one or more light-emitting diodes (e.g., 320 and possibly 322 and 324) may be used as the light emitter (instead of 20), the one or more photodiodes (e.g., 330 and possibly 332, 334, 335 and those corresponding to 332 and 334) may be used as the light detector (instead of 30), and the one or more processors 350, including a general purpose input/output (GPIO) and possibly an audio/digital converter for each differential amplifier, may be used as the one or more processors (instead of 120). Thus, in FIG. 1 in an embodiment, the light emitter in FIG. 1 may include those one or more light-emitting diodes (320, 322, 324), the light detector may include those one or more photodiodes (330, 332, 334, 335, two corresponding to 332 and 334), and the one or more processors may include the one or more processors 350. The chemical detector 1 with the aforementioned replacements may also include the one or more differential amplifiers 340, 342, and 344, in which case the one or more processors 350 may include an audio/digital converter for each amplifier.

In an embodiment, any of the chemical detectors embodiments described herein may include a removable memory card that may record calculations made by the one or more processors.

FIG. 5 illustrates a top view of a chemical detector 401, in accordance with one embodiment of the present invention. FIG. 6 illustrates a top view of an embodiment of elements that may be included in the interior of the housing 440 of the chemical detector 401 of FIG. 5. Thus, referring to FIGS. 5 and 6, the chemical detector 401 may include a chemically-activatable assembly 410, a light emitter 420, and a light detector 430. The chemically-activatable assembly 410 may include multiple materials each containing dyes, such as multiple materials 450, 452, 454, and 456 with each of those materials containing a different dye. The light emitter 420 may include multiple light-emitting elements such as light-emitting diodes 460, 462, 464, and 466, which each transmit light through all of the multiple materials (and thus their contained dyes) 450, 452, 454, and 456. The light detector 430 may include one or more photodiodes, such as described above, or another device or devices that detect rate of change of intensity of light. However, the chemically-activatable assembly 410 may be replaced by any other chemically-activatable assembly described herein, with a corresponding light emitter 420 and light detector 430 for that chemically-activatable assembly also substituted. Any other elements disposed in a housing of a chemical detector as described herein may be substituted or added in other embodiments.

Referring to FIG. 5, the housing 440 may have various elements disposed thereon, including a diffusion cover 500 and a status display that may include one or more indicator lights 510 and/or an indicator screen 520.

The diffusion cover 500 and status display may or may not be integral with the housing 440. The diffusion cover 500 may block most or all light from entering the chemical detector 401. In one embodiment, the diffusion cover 500 may be used in the chemical detector 1 of FIG. 1 in place of the diffusion screen. In another embodiment, the housing 440 may alternatively or also include a light blocking, permeable cover or membrane that is permeable to the desired chemicals while blocking most or all light.

As in the status display 70 embodiments of FIG. 1 above, the status display of FIG. 5 may include one or more indicator lights 510, such as light-emitting diodes, that may provide various indications such as those discussed above. The status display of FIG. 5 may also include the indicator screen 520, such as a liquid-crystal display or another display. The indicator screen 520 may provide data such as, for example, information a dosimeter may provide including chemical concentration and time of chemical exposure. The indicator screen 520 may also or alternatively include an alarm providing alarm data indicating a dangerous concentration of one or more chemicals or one or more concentrations approaching dangerous levels. The housing 440 may include control buttons (not shown) that may control the indicator screen 520 to display some or all of the aforementioned information.

Additionally, the chemical detector 401 may include a band 530 attached thereto. The band 530 may be formed like a watchband such that the band 530 may be fastened together around an object such as a wrist, and may thus be a fastenable band. The band 530 may be a fastenable band by including a buckle 532 and holes 534 for fastening the buckle 532 and thus the band 530 around a wearer's wrist. In other embodiments, the band 530 may be a fastenable band by other fastening means, such as means including a clasp. The band 530 may be made of leather, plastic, metal, or another substance or substances as desired. The band may be shaped and sized as desired to allow attachment to clothing, body parts, or elements of fixed or other location.

With respect to any of the aforementioned embodiments of the chemical detector (e.g. 1, 401), in another embodiment the dye or dyes (e.g. 220) of the material or materials (e.g., 210) may emit light, such as phosphorescent light, when exposed to one or more chemicals that activate that dye or dyes. In this embodiment, the chemical detector may not include a light emitter. The corresponding photodiodes and processor may detect and process the rate of change of light intensity transmitted to the photodiodes due to the luminescence of the dye or dyes and thereby detect the concentration of the chemical or chemicals.

While specific embodiments of the invention have been described in detail, it should be appreciated by those skilled in the art that various modifications and alternations and applications could be developed in light of the overall teachings of the disclosure. For example, in various embodiments, any of the chemical detector embodiments described herein (e.g., 1, 401) may be modified to detect high energy radiation such as x-rays, gamma rays, and/or beta rays. In each of these embodiments, the chemical detector may be renamed a high energy radiation detector and may use one or more scintillators to detect one or more types of high energy radiation. Each scintillator may be any desired scintillator, which may or may not include a dye. Because a scintillator emits its own light when stimulated by radiation, the high energy radiation detector may not have a light emitter (e.g. 20 or 320, 322, 324). Thus, for example, in the chemical detector 1, the material or materials (210 or one or more of 312, 360, 362 and those materials' corresponding reference materials (e.g., 316)) may each be replaced with a scintillator and the light emitter may be omitted, and the resulting detector may otherwise operate like the chemical detector 1 but detect high energy radiation instead of chemicals. Likewise, in the chemical detector 401, the materials 450, 452, 454, and 456 may each be replaced with a scintillator. In any of these embodiments, when a scintillator of the high energy radiation detector is exposed to certain high energy radiation, the luminescence of the scintillator may change. As with the chemical detector, the high energy radiation detector, via its corresponding photodiodes and processor, may detect and process the rate of change of light intensity transmitted to the photodiodes and thereby detect the concentration of the high energy radiation.

In various other embodiments, any of the chemical detector embodiments described herein (e.g., 1, 401) may be modified to detect biological substances. In each of these embodiments, the chemical detector may be renamed a biological substance detector and may use one or more elements that detect one or more biological substances. For example, in one such embodiment, at least one detecting element may include a color changing specific enzyme incorporated into a gel matrix or growth media, though in other embodiments other elements that detect biological substances may be used. Each element may be any biological-substance-detecting element desired, and may or may not include a dye. The material or materials (e.g., 210 or one or more of 312, 360, 362 and those materials' corresponding reference materials (e.g., 316) for the chemical detector 1 or 450, 452, 454, and 456 for the chemical detector 401) may each be replaced by one or more of such elements that detect one or more biological substances. As with the chemical detectors, the biological substance detector may detect and process, via its corresponding photodiodes and processor, the rate of change of light intensity transmitted from the corresponding light emitter and thereby detect the concentration of the biological substance or substances. In one embodiment of the biological substance detector, the light emitter transmits, and each photodiode detects the rate in change of light intensity of, ultraviolet light.

Accordingly, the particular arrangements products, and methods disclosed are meant to be illustrative only and not limiting as to the scope of the invention.

What is claimed is:

1. A chemical detector, comprising:
a material permeable to a chemical;
a dye contained by the material, the dye activatable by the chemical;
a light emitter to transmit light through the material and dye;
a light detector to detect the light; and
a housing, the material containing the dye, the light emitter, and the light detector disposed in the housing.

2. The chemical detector of claim 1, wherein the material is in the form of a strip.

3. The chemical detector of claim 2, wherein the strip comprises silicone.

4. The chemical detector of claim 1, wherein the material comprises a gel.

5. The chemical detector of claim 1, wherein material is impregnated with the dye.

6. The chemical detector of claim 1, further comprising a protective material that:
is disposed in the housing;
is different than the material;
is permeable to the chemical; and
contains the material.

7. The chemical detector of claim 6, wherein the protective material is a membrane.

8. The chemical detector of claim 7, wherein the material comprises a liquid.

9. The chemical detector of claim 7, wherein the material comprises a gel.

10. The chemical detector of claim 1, further comprising a reference material the same type and shape as the material, the reference material disposed in the housing, the light emitter to further transmit the light through the reference material.

11. The chemical detector of claim 10, further comprising:
a second dye the same type as the dye and contained by the reference material; and
a protective material containing the reference material and impermeable to the chemical.

12. The chemical detector of claim 1, further comprising one or more additional materials disposed in the housing, each of the one or more additional materials containing a different dye than that of the material and each other, the light emitter to further transmit light through the one or more additional materials.

13. The chemical detector of claim 12, wherein each of the material and additional materials is of a different type.

14. The chemical detector of claim 12, wherein for each of the one or more additional materials, the additional material is permeable to a different chemical and the dye contained by the additional material is activatable by a different chemical.

15. The chemical detector of claim 12, further comprising a plurality of reference materials disposed in the housing, each reference material the same shape and type as a different one of the material and the one or more additional materials.

16. The chemical detector of claim 1, further comprising one or more processors to determine the rate of change in intensity of light to be detected by the light detector, the one or more processors disposed in the housing.

17. The chemical detector of claim 1, further comprising a diffusion screen disposed in the housing.

18. The chemical detector of claim 1, wherein the material comprises an elongated element.

19. The chemical detector of claim 18, wherein the light to be transmitted by the light emitter is to be transmitted lengthwise through the elongated element.

20. A chemical detector, comprising:
a chemically-activatable assembly;
a housing, the chemically-activatable assembly disposed in the housing; and
a band, the band attached to the housing.

21. The chemical detector of claim 20, further comprising a diffusion cover disposed on the housing.

22. The chemical detector of claim 20, further comprising a holder including a recess to position the chemically-activatable assembly therein, the holder disposed in the housing.

23. The chemical detector of claim 20, further comprising a status display disposed on the housing.

24. The chemical detector of claim 20, wherein the housing comprises a main housing and an outer housing.

25. The chemical detector of claim 20, further comprising a battery, the battery disposed in the housing.

26. A chemical detector, comprising:
a chemically-activatable assembly disposed in the housing and comprising one or more materials and a plurality of different dyes, each of the plurality of different dyes each contained by one of the one or more materials;
means for transmitting light through the chemically-activatable assembly;
means for detecting the light; and
a housing, the chemically-activatable assembly, the means for transmitting light through the chemically-activatable assembly, and the means for detecting the light disposed in the housing.

27. The chemical detector of claim 26, further comprising an alarm disposed in the housing.

28. The chemical detector of claim 26, further comprising a status display disposed on the housing.

29. The chemical detector of claim 28, wherein the status display includes one or more indicator lights.

30. The chemical detector of claim 29, wherein the status display includes an indicator screen.
